(19) United States
(12) Patent Application Publication
(10) Pub. No.: US 2025/0183963 A1
(43) Pub. Date: Jun. 5, 2025

(54) INFORMATION TRANSMISSION METHOD AND APPARATUS, AND DEVICE AND STORAGE MEDIUM

(71) Applicant: Beijing Xiaomi Mobile Software Co., Ltd., Beijing (CN)

(72) Inventor: Mingju LI, Beijing (CN)

(73) Assignee: Beijing Xiaomi Mobile Software Co., Ltd., Beijing (CN)

(21) Appl. No.: 18/844,206

(22) PCT Filed: Mar. 11, 2022
(86) PCT No.: PCT/CN2022/080458

§ 371 Date: Sep. 5, 2024

(51) Int. Cl. H04B 7/06

(52) U.S. Cl. CPC H04B 7/0626; H04B 7/0663

(57) ABSTRACT

The present application relates to the field of mobile communications. Disclosed are an information transmission method and apparatus, and a device and a storage medium. The method comprises: a terminal sending channel state information to a network device, wherein the channel state information comprises channel state information corresponding to at least two layers, or the channel state information comprises channel state information corresponding to at least two sub-bands, and the channel state information indicates an amplitude coefficient of each layer or sub-band. Therefore, a network device can determine the difference between amplitude coefficients of two layers or the difference between amplitude coefficients of two sub-bands, that is to say, parameters of the amplitude coefficients are added to channel state information which is reported by a terminal, such that the information amount which can be carried by the information is expanded; and since the terminal reports the difference between the amplitude coefficients of different layers or different sub-bands, the network device can know the difference between the amplitude coefficients of different layers or different sub-bands, and then communicate with the terminal on the basis of the acquired amplitude coefficients, thereby ensuring the reliability of communication.

### TECHNICAL FIELD

The present disclosure relates to the field of mobile communications, and in particular to an information transmission method, apparatus, device and storage medium.

### BACKGROUND

In a mobile communication system, a terminal can measure a channel to obtain channel status information of each port, and compress the channel status information of each port to feed it back to a network device. The network device then determines the relative amplitude value of each port based on the compressed channel status information. However, the amount of information determined based on the channel status information is small, and communication reliability is poor.

### SUMMARY

The embodiments of the present application provide an information transmission method, apparatus, device and storage medium, in which a parameter of the amplitude coefficient is added in the channel state information reported by the terminal, and the amount of information that the information can carry is increased. Also, because the terminal reports the difference in the amplitude coefficients between different layers or different sub-bands, the network device can know the difference in the amplitude coefficients between different layers or different sub-bands, thereby communicating with the terminal based on the acquired amplitude coefficient to ensure the reliability of communication. The technical solution is as follows.

According to one aspect of the present application, there is provided an information transmission method, the method being executed by a terminal, the method including:
sending channel state information to a network device, wherein the channel state information includes channel state information corresponding to at least two layers, or the channel state information includes channel state information corresponding to at least two subbands, and the channel state information indicates an amplitude coefficient of each layer or each subband.

According to one aspect of the present application, there is provided an information transmission method, the method being performed by a network device, the method including:
receiving channel state information sent by a terminal, wherein the channel state information includes channel state information corresponding to at least two layers, or the channel state information includes channel state information corresponding to at least two subbands, and the channel state information indicates an amplitude coefficient of each layer or each subband.

According to one aspect of the present application, there is provided an information transmission apparatus, including:
a sending module, configured to send channel state information to a network device, wherein the channel state information includes channel state information corresponding to at least two layers, or the channel state information includes channel state information corresponding to at least two subbands, and the channel state information indicates an amplitude coefficient of each layer or each subband.

According to one aspect of the present application, there is provided an information transmission apparatus, including:
a receiving module, configured to receive channel state information sent by a terminal, wherein the channel state information includes channel state information corresponding to at least two layers, or the channel state information includes channel state information corresponding to at least two subbands, and the channel state information indicates an amplitude coefficient of each layer or each subband.

According to one aspect of the present application, a terminal is provided, including: a processor; a transceiver connected to the processor; and a memory for storing executable instructions of the processor; wherein the processor is configured to load and execute the executable instructions to implement the information transmission method as described above.

According to one aspect of the present application, a network device is provided, including: a processor; a transceiver connected to the processor; and a memory for storing executable instructions of the processor; wherein the processor is configured to load and execute the executable instructions to implement the information transmission method as described above.

According to one aspect of the present application, a computer-readable storage medium is provided, in which executable program code is stored. The executable program code is loaded and executed by a processor to implement the information transmission method as described above.

In the implementation provided in the embodiment of the present application, the terminal reports the amplitude coefficients corresponding to at least two layers or at least two sub-bands to the network device, so that the network device can determine the difference in the amplitude coefficients between the two layers or the difference in the amplitude coefficients between the two sub-bands. That is to say, the parameter of the amplitude coefficient is added to the channel state information reported by the terminal, and the amount of information that can be carried by the information is expanded. Moreover, since the terminal reports the difference in amplitude coefficients between different layers or different sub-bands, the network device can obtain the difference in amplitude coefficients between different layers or different sub-bands, and then communicate with the terminal based on the obtained amplitude coefficient to ensure the reliability of communication.

### BRIEF DESCRIPTION OF THE DRAWINGS

In order to more clearly illustrate the technical solutions in the embodiments of the present application, the drawings required for use in the description of the embodiments will be briefly introduced below. Obviously, the drawings described below are only some embodiments of the present application. For those skilled in the art, other drawings can be obtained based on these drawings without paying any creative effort.

FIG. 1 illustrates a block diagram of a communication system provided by an exemplary embodiment of the present application;

FIG. 2 illustrates a flow chart of an information transmission method provided by an exemplary embodiment of the present application;

FIG. 3 illustrates a flow chart of an information transmission method provided by an exemplary embodiment of the present application;

FIG. 4 illustrates a flow chart of an information transmission method provided by an exemplary embodiment of the present application;

FIG. 5 illustrates a block diagram of an information transmission apparatus provided by an exemplary embodiment of the present application;

FIG. 6 illustrates a block diagram of an information transmission apparatus provided by an exemplary embodiment of the present application;

FIG. 7 illustrates a schematic diagram of the structure of a communication device provided by an exemplary embodiment of the present application.

### DETAILED DESCRIPTION

In order to make the objectives, technical solutions and advantages of the present application more clear, the implementation methods of the present application will be further described in detail below with reference to the accompanying drawings.

Exemplary embodiments will be described in detail herein, examples of which are shown in the accompanying drawings. Unless otherwise indicated, the same numbers in different drawings represent the same or similar elements when the following description refers to the drawings. The embodiments described in the following exemplary embodiments do not represent all embodiments consistent with the present application. Instead, they are merely examples of devices and methods consistent with some aspects of the present application as detailed in the appended claims.

The terms used in this application are only for the purpose of describing specific embodiments and are not intended to limit this application. The singular forms of “a”, “a”, “an” and “the” used in this application and the appended claims are also intended to include plural forms, unless the context clearly indicates other meanings. It should also be understood that the term “and/or” used in this article refers to and includes any or all possible combinations of one or more associated listed items.

It should be understood that, although the terms first, second, third, etc. may be used in the present application to describe various information, these information should not be limited to these terms. These terms are only used to distinguish the same type of information from each other. For example, without departing from the scope of the present application, the first information may also be referred to as the second information, and similarly, the second information may also be referred to as the first information. Depending on the context, for example, the word “if” used herein may be interpreted as “at the time of” or “when” or “in response to determining”.

It should be noted that the information (including but not limited to user device information, user personal information, etc.), data (including but not limited to data used for analysis, stored data, displayed data, etc.) and signals involved in this application are all authorized by the user or fully authorized by all parties, and the collection, use and processing of relevant data must comply with relevant laws, regulations and standards of relevant countries and regions.

Hereinafter, the application scenarios of this application are illustrated.

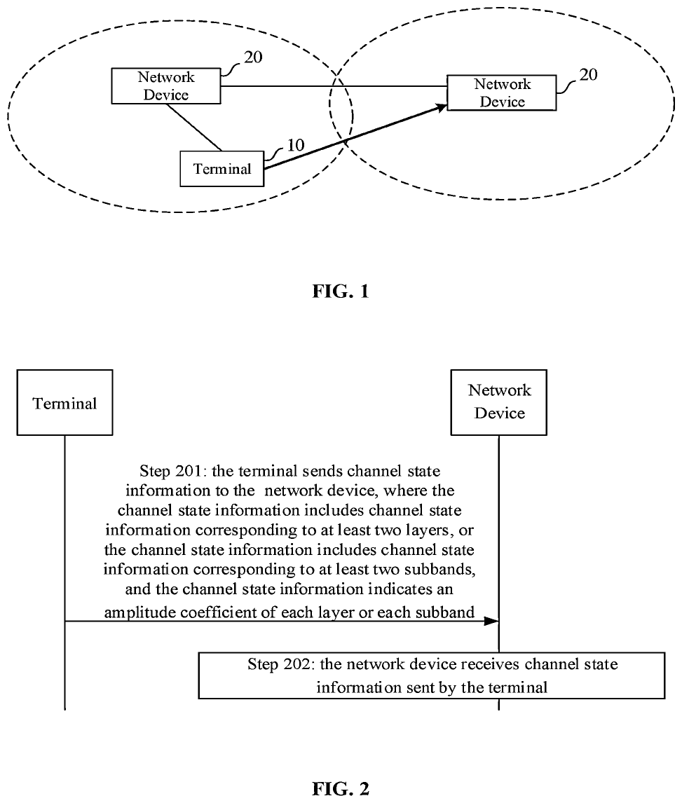

FIG. 1 illustrates a block diagram of a communication system provided by an exemplary embodiment of the present application. The communication system may include: a terminal 10 and a network device 20.

The terminal 10 is generally plural in number, and one or more terminals 10 may be distributed in a cell managed by each network device 20. The terminal 10 may include various handheld devices, vehicle-mounted devices, wearable devices, computing devices, or other processing devices connected to a wireless modem, as well as various forms of user equipment (UE), mobile stations (MS), etc, that have wireless communication functions. For the convenience of description, in the embodiments of the present application, the above-mentioned devices are collectively referred to as terminals.

The network device 20 is a device deployed in the access network to provide a wireless communication function for the terminal 10. For the convenience of description, in the embodiments of the present application, the above-mentioned devices that provide wireless communication functions for the terminal 10 are collectively referred to as network devices. A connection can be established between the network device 20 and the terminal 10 through an air interface, so that communication is performed through the connection, including the interaction of signaling and data. There can be multiple network devices 20, and two adjacent network devices 20 can also communicate with each other in a wired or wireless manner. The terminal 10 can switch between different network devices 20, that is, establish connections with different network devices 20.

The network device 20 may include various forms of macro base stations, micro base stations, relay stations, access points, etc. In systems using different radio access technologies (RATs), the name of the device with network device function may be different, for example, in the 5G NR system, it is called gNodeB or gNB. With the evolution of communication technology, the name of “network device” may change.

FIG. 2 illustrates a flowchart of an information transmission method provided by an exemplary embodiment of the present application, which can be performed by the terminal and the network device shown in FIG. 1, and the method includes at least part of the following contents.

Step 201: The terminal sends channel state information to a network device, where the channel state information includes channel state information corresponding to at least two layers, or the channel state information includes channel state information corresponding to at least two subbands, and the channel state information indicates an amplitude coefficient of each layer or each subband.

In an embodiment of the present application, the terminal may send channel state information corresponding to at least two layers or at least two subbands to a network device, and use the channel state information to indicate the amplitude coefficient of each layer or each subband to inform the network device of the amplitude coefficient of each layer or each subband.

In the embodiment, the layer is the number of layers transmitted by the terminal. Further, the number of layers is defined as the RANK (rank) of the MIMO (Multiple Input Multiple Output) channel matrix. That is, the number of layers of the terminal is equal to the RANK number. When the RANK is 1, the number of layers is 1, and when the RANK is N, the number of layers is N. The amplitude coefficient indicates the amplitude of the signal transmitted by the layer or subband.

It should be noted that the channel state information in the embodiments of the present application includes channel state information corresponding to at least two layers, or includes channel state information corresponding to at least two subbands. When the channel state information includes channel state information corresponding to at least two layers, the channel state information indicates the amplitude coefficient of each layer, and when the channel state information includes channel state information corresponding to at least two subbands, the channel state information indicates the amplitude coefficient of each subband.

Step 202: The network device receives channel state information sent by the terminal.

In an embodiment of the present application, the network device receives channel state information sent by the terminal, and can determine the amplitude coefficient of each layer in at least two layers based on the channel state information, or determine the amplitude coefficient of each subband in at least two subbands based on the channel state information.

It should be noted that the steps executed by the terminal in the embodiment of the present application can be implemented separately to form a new embodiment, and the steps executed by the network device can be implemented separately to form a new embodiment.

In the implementation provided in the embodiment of the present application, the terminal reports the amplitude coefficients corresponding to at least two layers or at least two sub-bands to the network device, so that the network device can determine the difference in the amplitude coefficients between the two layers or the difference in the amplitude coefficients between the two sub-bands. That is to say, the parameters of the amplitude coefficient are added to the channel state information reported by the terminal, and the amount of information that can be carried by the information is expanded. Moreover, since the terminal reports the difference in amplitude coefficients between different layers or different sub-bands, the network device can obtain the difference in amplitude coefficients between different layers or different sub-bands, and then communicate with the terminal based on the obtained amplitude coefficient to ensure the reliability of communication.

Based on the embodiment shown in FIG. 2, the terminal indicates the amplitude coefficient through vector information. That is, by carrying vector information in the channel state information, then the amplitude coefficient is indicated through the vector information, the following two situations are included.

The first type: the channel state information includes vector information corresponding to each layer, and the vector information indicates an amplitude coefficient of the layer.

In the embodiment of the present application, the channel state information includes vector information corresponding to each layer, that is, the vector information corresponding to each layer indicates the amplitude coefficient of the layer. In the embodiment, the layer is layer, RANK=1 corresponds to one layer, and the RANK value is N, which means that N layers are supported.

The second type: the channel state information includes vector information corresponding to each subband, and the vector information indicates the amplitude coefficient of the subband.

In the embodiment of the present application, the channel state information includes vector information corresponding to each sub-band, that is, the vector information corresponding to each sub-band indicates the amplitude coefficient of the sub-band.

Optionally, the vector information includes a characteristic vector or a singular vector. When the vector information includes a characteristic vector, the amplitude coefficient is indicated by the characteristic vector. When the vector information includes a singular vector, the amplitude coefficient is indicated by the singular vector.

In some embodiments, the vector information includes first bit information, and the first bit information has a corresponding relationship with an element in the vector information.

In an embodiment of the present application, the first bit information included in the vector information indicates the value of the element included in the vector information. In the embodiment, the first bit information has a corresponding relationship with the element in the vector information, and the value of the element in the vector information can be determined by the first bit information and the corresponding relationship.

For example, if the vector information includes elements a, b, c, and d, the first bit information means that 000 indicates that the values corresponding to a, b, c, and d are 1, 2, 5, and 3 respectively; and 001 indicates that the values corresponding to a, b, c, and d are 3, 4, 1, and 3 respectively. Alternatively, the first bit information has other corresponding relationships with the elements.

In another embodiment of the present application, multiple vectors can be combined into a matrix, and the vector information includes first bit information for indicating the matrix combined from the multiple vectors, and the first bit information has a corresponding relationship with the elements in the matrix.

It should be noted that the elements in the vector information in the embodiment of the present application include the amplitude coefficient corresponding to at least one port, or the elements in the vector information include the corresponding amplitude coefficient corresponding to at least one beam.

In the embodiment, for each layer, each layer includes at least one port, and the vector information corresponding to each layer includes the amplitude coefficient of at least one port included in the layer, that is, the value of each element included in the vector information is the amplitude coefficient of a port.

In the embodiment, for each subband, each subband includes at least one beam, and the vector information corresponding to each subband includes the amplitude coefficient of at least one beam included in the subband, that is, the value of each element included in the vector information is the amplitude coefficient of a beam.

In the embodiment, the port refers to CSI-RS (Channel State Information Reference Signal) port, or, antenna port. The beam refers to a beam.

It should be noted that, in the embodiment of the present application, when the terminal feeds back channel state information, the feedback is based on AI.

In some embodiments, when the terminal feeds back the channel state information, it normalizes the vector information of the channel state information and feeds back the normalized channel state information.

In the implementation provided by the embodiment of the present application, the amplitude coefficient corresponding to each layer or subband is indicated by including vector information in the channel state information, so as to facilitate the terminal to report the amplitude coefficients corresponding to at least two layers or at least two subbands. Since the terminal reports the amplitude coefficients of the layers or subbands, the network device can obtain the amplitude coefficients of the relevant layers or subbands, and then communicate with the terminal based on the acquired amplitude coefficients, thereby improving the reliability of communication.

Based on the above embodiment, the amplitude coefficient can be determined according to the length of the vector information. The following describes how to determine the amplitude coefficient.

In some embodiments, the amplitude coefficient of each layer in the at least two layers is the length of the vector information corresponding to the layer.

In an embodiment of the present application, when determining the amplitude coefficient of each layer in at least two layers, the length of the vector information corresponding to each layer is determined as the amplitude coefficient of the layer, and the amplitude coefficient of each layer is associated with the amplitude coefficient corresponding to at least one port included in the vector information.

Optionally, in response to the vector information being a real number vector, the length of the vector information is the sum of the absolute values of each element in the real number vector.

For example, for a vector [a, b, c, d], the length of the vector is the sum of the absolute values of a, b, c, d. When feedback of channel state information is provided, the vector is normalized so that its length is 1, that is, each element of the vector is divided by the length of the vector.

Optionally, in response to the vector information being a complex vector, the length of the vector information is the sum of the modulus of each element in the complex vector.

For example, a vector [a+i*a′, b+i*b′, c+i*c′, d+i*d′], the length of which is the sum value of the modulus of each element, that is, the sum value is the sum of square roots of the quadratic sum of a and a′, b and b′, c and c′, respectively. When the channel state information is fed back, the vector is normalized so that its length is 1, that is, the real part and the imaginary part of each element of the vector are divided by the length of the vector.

In some other embodiments, the amplitude coefficient of each subband in at least two subbands is the length of the vector information corresponding to the subband, and the amplitude coefficient of each subband is associated with the amplitude coefficient corresponding to at least one beam included in the vector information.

In the embodiment of the present application, when determining the amplitude coefficient of each sub-band in at least two sub-bands, the length of the vector information corresponding to each sub-band is determined as the amplitude coefficient of the sub-band.

In addition, when determining the amplitude coefficient of each sub-band, it is similar to determining the amplitude coefficient of each layer in the above embodiment, and will not be repeated here.

It should be noted that in the embodiment of the present application, the difference in amplitude coefficients between different layers or subbands is indicated by the length of the vector information, and when the channel state information is fed back, the vector is normalized. During the normalization process, for the network device, since the length of the vector information indicates the amplitude coefficient, the length of the vector information with the largest amplitude coefficient is normalized to 1, and the normalized length 1 is used as the amplitude coefficient of the vector information with the largest amplitude coefficient. For other vector information whose amplitude coefficient is less than the amplitude coefficient of the vector information with the largest amplitude coefficient, the normalized length of the other vector information is determined according to the ratio of the amplitude coefficient of the other vector information to the amplitude coefficient of the vector information with the largest amplitude coefficient, and the normalized length of the other vector information is determined as the amplitude coefficient of the other vector information. Therefore, the network device can determine the difference in amplitude coefficients between different vectors based on the first bit of information in the vector information.

In some embodiments, the length of the vector information with the largest amplitude coefficient is normalized to 1, and the normalized length 1 is used as the amplitude coefficient of the vector information. That is, the amplitude coefficient of the vector information with the largest amplitude coefficient is the length 1 of the vector information. For other vector information, the ratio of the amplitude coefficient of the other vector information to the amplitude coefficient of the vector information with the largest amplitude coefficient is used as the normalized length of the other vector information, and the normalized length of the other vector information is used as the amplitude coefficient of the other vector information.

For example, two pieces of vector information are used as an example for explanation. The two pieces of vector information are vector 1 and vector 2, respectively. The amplitude coefficient of vector 1 is greater than the amplitude coefficient of vector 2. For vector 1, the length of vector 1 is normalized to 1, and the length of vector 2 is normalized to 1/L, where L is the ratio of the amplitude coefficient of vector 1 to the amplitude coefficient of vector 2. That is, the embodiment of the present application indicates the amplitude coefficients of different vectors by the ratio of the lengths of the two pieces of vector information, and the difference in amplitude coefficients between different vector information can be determined by indicating the first bit of the vector information.

In the solution provided in the embodiment of the present application, the amplitude coefficient of the layer or subband is determined by the length of the vector information, which saves signaling overhead and improves the reliability of communication.

Based on the above embodiment, the amplitude coefficient may be determined according to the second bit information included in the channel state information. Hereinafter, how to determine the amplitude coefficient is illustrated.

In some embodiments, the channel state information includes second bit information, and the amplitude coefficient of each layer in the at least two layers is indicated by the second bit information.

In an embodiment of the present application, the terminal indicates the amplitude coefficient of each layer through the second bit information in the channel state information.

Optionally, the second bit information indicates a differential value between an amplitude coefficient of the second layer and an amplitude coefficient of the first layer, and the amplitude coefficient of the first layer is 1.

In the embodiment, the amplitude coefficient of the first layer is agreed upon by the communication protocol or pre-set by the terminal, and is not limited in the embodiment of the present application.

For example, the first layer includes layer 1, the second layer includes layer 2 and layer 3, the differential value indicated by the second bit information corresponding to layer 2 is 0.2, then the amplitude coefficient of layer 2 is 0.2 times that of layer 1, and the differential value indicated by the second bit information corresponding to layer 3 is 0.1, then the amplitude coefficient of layer 3 is 0.1 times that of layer 1.

Optionally, the second bit information directly indicates the amplitude coefficient of each layer. For example, the second bit information indicates the amplitude coefficients of three layers, namely, layer 1, layer 2 and layer 3, and the second bit information indicates that the amplitude coefficient of layer 1 is 1, the amplitude coefficient of layer 2 is 0.8, and the amplitude coefficient of layer 3 is 0.5.

In some other embodiments, the channel state information includes second bit information, and the amplitude coefficient of each subband in the at least two subbands is indicated by the second bit information.

In an embodiment of the present application, the terminal indicates the amplitude coefficient of each subband through the second bit information in the channel state information.

Optionally, the second bit information indicates a differential value between an amplitude coefficient of the second sub-band and an amplitude coefficient of the first sub-band, and the amplitude coefficient of the first sub-band is 1.

In the embodiment, the amplitude coefficient of the first sub-band is agreed upon by the communication protocol or pre-set by the terminal, and is not limited in the embodiment of the present application.

For example, the first subband includes subband 1, the second subband includes subband 2 and subband 3, the differential value indicated by the second bit information corresponding to subband 2 is 0.2, then the amplitude coefficient of subband 2 is 0.2 times that of subband 1, and the differential value indicated by the second bit information corresponding to subband 3 is 0.1, then the amplitude coefficient of subband 3 is 0.1 times that of subband 1.

In the embodiment, the second bit information of the embodiment of the present application is similar to that of the layer of the above-mentioned embodiment, and will not be repeated here.

In the implementation provided in the embodiment of the present application, by adding a second bit of information in the channel state information to indicate the amplitude coefficient of the layer or subband, the accuracy of the indicated amplitude coefficient is improved, thereby ensuring the reliability of communication.

It should be noted that the channel state information in the embodiment of the present application may include not only the second bit information, but also the first bit information in the above embodiment.

In the embodiment, the first bit information is similar to that in the above embodiment and will not be repeated here.

In the implementation provided by the embodiment of the present application, the network device can not only determine the vector information indicated by the first bit information, and then determine the amplitude coefficient of each port or beam based on the amplitude coefficient indicated by the element of the vector information, but also determine the amplitude coefficients of different layers or different subbands indicated by the second bit information, so that the network device can increase the information for reference when communicating with the terminal based on the amplitude coefficient of the layer or subband, and the amplitude coefficient of the port included in the layer or the beam included in the subband, thereby further improving the communication reliability.

Based on the embodiment shown in FIG. 2, the terminal carries third bit information in the channel state information, and indicates a CQI (Channel Quality Indication) corresponding to each layer in at least two layers through the third bit information.

In the embodiment of the present application, the terminal not only reports the amplitude coefficient of each layer, but also reports the CQI of each layer, and the terminal indicates the CQI of each layer by carrying the third bit information in the channel state information.

Optionally, the third bit information indicates an absolute value of a CQI corresponding to each layer.

Optionally, the third bit information indicates a differential value between the CQI of the second layer and the CQI of the first layer, and the CQI of the first layer is an absolute value of the CQI.

For example, the product or sum of the differential value of the CQI of the second layer and the absolute value of the CQI of the first layer is determined as the value of the CQI of the second layer.

For example, the CQI of the second layer includes a first CQI, a second CQI, and a third CQI, and the differential value indicated by the third bit information corresponding to the first CQI is 0.4, then the first CQI is the product or sum of 0.4 and the absolute value of the first-layer CQI, the differential value indicated by the third bit information corresponding to the second CQI is 0.5, then the first CQI is the product or sum of 0.5 and the absolute value of the first-layer CQI, and the differential value indicated by the third bit information corresponding to the third CQI is 0.7, then the first CQI is the product or sum of 0.7 and the absolute value of the first-layer CQI.

After receiving the channel state information sent by the terminal, the network device can determine the CQI corresponding to each layer based on the third bit information included in the channel state information.

In the embodiment, the network device can determine the absolute value of the CQI of the first layer based on the third bit information, and can also determine the differential value between the CQI of the second layer and the CQI of the first layer. Therefore, the CQI corresponding to each layer is determined according to the differential value of each CQI of the second layer and the absolute value of the CQI of the first layer.

Furthermore, the method for determining the CQI of the second layer is similar to the above, which will not be described in detail here.

In the solution provided in the embodiment of the present application, the terminal indicates the CQI corresponding to each layer by carrying the third bit information in the channel state information, thereby increasing the amount of information transmission, and the CQI can indicate the channel quality, so that the network device can transmit data based on the CQI, thereby ensuring the reliability of communication.

On the basis of the embodiment shown in FIG. 2, the terminal carries third bit information in the channel state information, and the third bit information indicates the CQI corresponding to each subband in at least two subbands.

In the embodiment of the present application, the terminal not only reports the amplitude coefficient of each subband, but also reports the CQI of each subband, and the terminal indicates the CQI of each subband by carrying the third bit information in the channel state information.

Optionally, the third bit information indicates an absolute value of a CQI corresponding to each subband.

Optionally, the third bit information indicates a differential value between the CQI of the second subband and the CQI of the first subband, and the CQI of the first subband is an absolute value of the CQI.

For example, the product or sum of the differential value of the CQI of the second subband and the absolute value of the CQI of the first subband is determined as the value of the CQI of the second subband.

For example, the CQI of the second subband includes the first CQI, the second CQI and the third CQI, and the differential value indicated by the third bit information corresponding to the first CQI is 0.4, then the first CQI is the product or sum of 0.4 and the absolute value of the first subband CQI, the differential value indicated by the third bit information corresponding to the second CQI is 0.5, then the first CQI is the product or sum of 0.5 and the absolute value of the first subband CQI, and the differential value indicated by the third bit information corresponding to the third CQI is 0.7, then the first CQI is the product or sum of 0.7 and the absolute value of the first subband CQI.

After receiving the channel state information sent by the terminal, the network device determines the CQI corresponding to each subband based on the third bit information included in the channel state information.

In the embodiment, after the network device receives the third bit of information, it can determine the absolute value of the CQI of the first subband, and can also determine the differential value between the CQI of the second subband and the CQI of the first subband. Therefore, according to the differential value of each CQI of the second subband and the absolute value of the CQI of the first subband, the CQI corresponding to each subband is determined.

Also, the manner of determining the CQI of the second subband is similar to the above, which will not be described in detail herein.

In the solution provided in the embodiment of the present application, the terminal indicates the CQI corresponding to each subband by carrying the third bit information in the channel state information, thereby improving the information transmission amount, and the CQI can indicate the channel quality, so that the network device can transmit data based on the CQI, thereby ensuring the reliability of communication.

It should be noted that the above-mentioned embodiments can be split into new embodiments, or combined with other embodiments to form new embodiments. This application does not limit the combination between the embodiments.

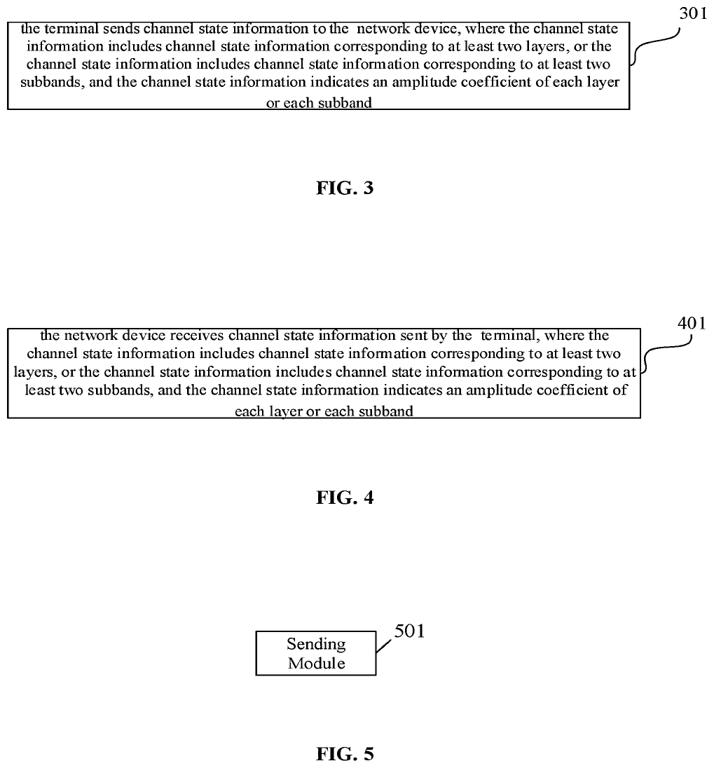

FIG. 3 illustrates a flow chart of an information transmission method provided by an exemplary embodiment of the present application. Referring to FIG. 3, the method includes:

Step 301: The terminal sends channel state information to a network device, where the channel state information includes channel state information corresponding to at least two layers, or the channel state information includes channel state information corresponding to at least two subbands, and the channel state information indicates an amplitude coefficient of each layer or each subband.

In an embodiment of the present application, the terminal may send channel state information corresponding to at least two layers or at least two subbands to a network device, and use the channel state information to indicate the amplitude coefficient of each layer or each subband to inform the network device of the amplitude coefficient of each layer or each subband.

In the embodiment, the layer is the number of layers transmitted by the terminal. Further, the number of layers is defined as the RANK (rank) of the MIMO channel matrix. That is, the number of layers of the terminal is equal to the RANK number. When the RANK is 1, the number of layers is 1, and when the RANK is N, the number of layers is N. The amplitude coefficient indicates the amplitude of the signal transmitted by the layer or subband.

It should be noted that the channel state information in the embodiments of the present application includes channel state information corresponding to at least two layers, or includes channel state information corresponding to at least two subbands. When the channel state information includes channel state information corresponding to at least two layers, the channel state information indicates the amplitude coefficient of each layer, and when the channel state information includes channel state information corresponding to at least two subbands, the channel state information indicates the amplitude coefficient of each subband.

By carrying vector information in the channel state information, then the amplitude coefficient is indicated through the vector information, the following two situations are included.

The first type: the channel state information includes vector information corresponding to each layer, and the vector information indicates an amplitude coefficient of the layer.

In the embodiment of the present application, the channel state information includes vector information corresponding to each layer, that is, the vector information corresponding to each layer indicates the amplitude coefficient of the layer. In the embodiment, the layer is layer, RANK=1 corresponds to one layer, and the RANK value is N, which means that N layers are supported.

The second type: the channel state information includes vector information corresponding to each subband, and the vector information indicates the amplitude coefficient of the subband.

In the embodiment of the present application, the channel state information includes vector information corresponding to each sub-band, that is, the vector information corresponding to each sub-band indicates the amplitude coefficient of the sub-band.

Optionally, the vector information includes a characteristic vector or a singular vector. When the vector information includes a characteristic vector, the amplitude coefficient is indicated by the characteristic vector. When the vector information includes a singular vector, the amplitude coefficient is indicated by the singular vector.

In some embodiments, the vector information includes first bit information, and the first bit information has a corresponding relationship with an element in the vector information.

In an embodiment of the present application, the first bit information included in the vector information indicates the value of the element included in the vector information. In the embodiment, the first bit information has a corresponding relationship with the element in the vector information, and the value of the element in the vector information can be determined by the first bit information and the corresponding relationship.

For example, if the vector information includes elements a, b, c, and d, the first bit information means that 000 indicates that the values corresponding to a, b, c, and d are 1, 2, 5, and 3 respectively; and 001 indicates that the values corresponding to a, b, c, and d are 3, 4, 1, and 3 respectively. Alternatively, the first bit information has other corresponding relationships with the elements.

In another embodiment of the present application, multiple vectors can be combined into a matrix, and the vector information includes first bit information for indicating the matrix combined from the multiple vectors, and the first bit information has a corresponding relationship with the elements in the matrix.

In some embodiment, the elements in the vector information include the amplitude coefficient corresponding to at least one port, or the elements in the vector information include the corresponding amplitude coefficient corresponding to at least one beam.

In the embodiment, for each layer, each layer includes at least one port, and the vector information corresponding to each layer includes the amplitude coefficient of at least one port included in the layer, that is, the value of each element included in the vector information is the amplitude coefficient of a port.

In the embodiment, for each subband, each subband includes at least one beam, and the vector information corresponding to each subband includes the amplitude coefficient of at least one beam included in the subband, that is, the value of each element included in the vector information is the amplitude coefficient of a beam.

In the embodiment, the port refers to CSI-RS (Channel State Information Reference Signal) port, or, antenna port. The beam refers to a beam.

In some embodiments, the amplitude coefficient of each layer in the at least two layers is the length of the vector information corresponding to the layer.

In an embodiment of the present application, when determining the amplitude coefficient of each layer in at least two layers, the length of the vector information corresponding to each layer is determined as the amplitude coefficient of the layer, and the amplitude coefficient of each layer is associated with the amplitude coefficient corresponding to at least one port included in the vector information.

Optionally, in response to the vector information being a real number vector, the length of the vector information is the sum of the absolute values of each element in the real number vector.

For example, for a vector [a, b, c, d], the length of the vector is the sum of the absolute values of a, b, c, d. When feedback of channel state information is provided, the vector is normalized so that its length is 1, that is, each element of the vector is divided by the length of the vector.

Optionally, in response to the vector information being a complex vector, the length of the vector information is the sum of the modulus of each element in the complex vector.

For example, a vector [a+i*a′, b+i*b′, c+i*c′, d+i*d′], the length of which is the sum value of the modulus of each element, that is, the sum value is the sum of square roots of the quadratic sum of a and a′, b and b′, c and c′, respectively. When the channel state information is fed back, the vector is normalized so that its length is 1, that is, the real part and the imaginary part of each element of the vector are divided by the length of the vector.

In some other embodiments, the amplitude coefficient of each subband in at least two subbands is the length of the vector information corresponding to the subband, and the amplitude coefficient of each subband is associated with the amplitude coefficient corresponding to at least one beam included in the vector information.

In the embodiment of the present application, when determining the amplitude coefficient of each sub-band in at least two sub-bands, the length of the vector information corresponding to each sub-band is determined as the amplitude coefficient of the sub-band.

In addition, when determining the amplitude coefficient of each sub-band, it is similar to determining the amplitude coefficient of each layer in the above embodiment, and will not be repeated here.

It should be noted that in the embodiment of the present application, the difference in amplitude coefficients between different layers or subbands is indicated by the length of the vector information, and when the channel state information is fed back, the vector is normalized. During the normalization process, for the network device, since the length of the vector information indicates the amplitude coefficient, the length of the vector information with the largest amplitude coefficient is normalized to 1, and the normalized length 1 is used as the amplitude coefficient of the vector information with the largest amplitude coefficient. For other vector information whose amplitude coefficient is less than the amplitude coefficient of the vector information with the largest amplitude coefficient, the normalized length of the other vector information is determined according to the ratio of the amplitude coefficient of the other vector information to the amplitude coefficient of the vector information with the largest amplitude coefficient, and the normalized length of the other vector information is determined as the amplitude coefficient of the other vector information. Therefore, the network device can determine the difference in amplitude coefficients between different vectors based on the first bit of information in the vector information.

In some embodiments, the length of the vector information with the largest amplitude coefficient is normalized to 1, and the normalized length 1 is used as the amplitude coefficient of the vector information. That is, the amplitude coefficient of the vector information with the largest amplitude coefficient is the length 1 of the vector information. For other vector information, the ratio of the amplitude coefficient of the other vector information to the amplitude coefficient of the vector information with the largest amplitude coefficient is used as the normalized length of the other vector information, and the normalized length of the other vector information is used as the amplitude coefficient of the other vector information.

For example, two pieces of vector information are used as an example for explanation. The two pieces of vector information are vector 1 and vector 2, respectively. The amplitude coefficient of vector 1 is greater than the amplitude coefficient of vector 2. For vector 1, the length of vector 1 is normalized to 1, and the length of vector 2 is normalized to 1/L, where L is the ratio of the amplitude coefficient of vector 1 to the amplitude coefficient of vector 2. That is, the embodiment of the present application indicates the amplitude coefficients of different vectors by the ratio of the lengths of the two pieces of vector information, and the difference in amplitude coefficients between different vector information can be determined by indicating the first bit of the vector information.

In some embodiments, the channel state information includes second bit information, and the amplitude coefficient of each layer in the at least two layers is indicated by the second bit information.

In an embodiment of the present application, the terminal indicates the amplitude coefficient of each layer through the second bit information in the channel state information.

Optionally, the second bit information indicates a differential value between an amplitude coefficient of the second layer and an amplitude coefficient of the first layer, and the amplitude coefficient of the first layer is 1.

In the embodiment, the amplitude coefficient of the first layer is agreed upon by the communication protocol or pre-set by the terminal, and is not limited in the embodiment of the present application.

For example, the first layer includes layer 1, the second layer includes layer 2 and layer 3, the differential value indicated by the second bit information corresponding to layer 2 is 0.2, then the amplitude coefficient of layer 2 is 0.2 times that of layer 1, and the differential value indicated by the second bit information corresponding to layer 3 is 0.1, then the amplitude coefficient of layer 3 is 0.1 times that of layer 1.

Optionally, the second bit information directly indicates the amplitude coefficient of each layer. For example, the second bit information indicates the amplitude coefficients of three layers, namely, layer 1, layer 2 and layer 3, and the second bit information indicates that the amplitude coefficient of layer 1 is 1, the amplitude coefficient of layer 2 is 0.8, and the amplitude coefficient of layer 3 is 0.5.

In some other embodiments, the channel state information includes second bit information, and the amplitude coefficient of each subband in the at least two subbands is indicated by the second bit information.

In an embodiment of the present application, the terminal indicates the amplitude coefficient of each subband through the second bit information in the channel state information.

Optionally, the second bit information indicates a differential value between an amplitude coefficient of the second sub-band and an amplitude coefficient of the first sub-band, and the amplitude coefficient of the first sub-band is 1.

In the embodiment, the amplitude coefficient of the first sub-band is agreed upon by the communication protocol or pre-set by the terminal, and is not limited in the embodiment of the present application.

For example, the first subband includes subband 1, the second subband includes subband 2 and subband 3, the differential value indicated by the second bit information corresponding to subband 2 is 0.2, then the amplitude coefficient of subband 2 is 0.2 times that of subband 1, and the differential value indicated by the second bit information corresponding to subband 3 is 0.1, then the amplitude coefficient of subband 3 is 0.1 times that of subband 1.

It should be noted that the channel state information in the embodiment of the present application may include not only the second bit information, but also the first bit information in the above embodiment.

In the embodiment, the first bit information is similar to that in the above embodiment and will not be repeated here.

In the implementation provided by the embodiment of the present application, the network device can not only determine the vector information indicated by the first bit information, and then determine the amplitude coefficient of each port or beam based on the amplitude coefficient indicated by the element of the vector information, but also determine the amplitude coefficients of different layers or different subbands indicated by the second bit information, so that the network device can increase the information for reference when communicating with the terminal based on the amplitude coefficient of the layer or subband, and the amplitude coefficient of the port included in the layer or the beam included in the subband, thereby further improving the communication reliability.

In some embodiments, the terminal carries third bit information in the channel state information, and indicates a CQI corresponding to each layer in at least two layers through the third bit information.

In the embodiment of the present application, the terminal not only reports the amplitude coefficient of each layer, but also reports the CQI of each layer, and the terminal indicates the CQI of each layer by carrying the third bit information in the channel state information.

Optionally, the third bit information indicates an absolute value of a CQI corresponding to each layer.

Optionally, the third bit information indicates a differential value between the CQI of the second layer and the CQI of the first layer, and the CQI of the first layer is an absolute value of the CQI.

For example, the product or sum of the differential value of the CQI of the second layer and the absolute value of the CQI of the first layer is determined as the value of the CQI of the second layer.

For example, the CQI of the second layer includes a first CQI, a second CQI, and a third CQI, and the differential value indicated by the third bit information corresponding to the first CQI is 0.4, then the first CQI is the product or sum of 0.4 and the absolute value of the first-layer CQI, the differential value indicated by the third bit information corresponding to the second CQI is 0.5, then the first CQI is the product or sum of 0.5 and the absolute value of the first-layer CQI, and the differential value indicated by the third bit information corresponding to the third CQI is 0.7, then the first CQI is the product or sum of 0.7 and the absolute value of the first-layer CQI.

After receiving the channel state information sent by the terminal, the network device can determine the CQI corresponding to each layer based on the third bit information included in the channel state information.

In the embodiment, the network device can determine the absolute value of the CQI of the first layer based on the third bit information, and can also determine the differential value between the CQI of the second layer and the CQI of the first layer. Therefore, the CQI corresponding to each layer is determined according to the differential value of each CQI of the second layer and the absolute value of the CQI of the first layer.

Furthermore, the method for determining the CQI of the second layer is similar to the above, which will not be described in detail here.

In the solution provided in the embodiment of the present application, the terminal indicates the CQI corresponding to each layer by carrying the third bit information in the channel state information, thereby increasing the amount of information transmission, and the CQI can indicate the channel quality, so that the network device can transmit data based on the CQI, thereby ensuring the reliability of communication.

On the basis of the embodiment shown in FIG. 2, the terminal carries third bit information in the channel state information, and the third bit information indicates the CQI corresponding to each subband in at least two subbands.

In the embodiment of the present application, the terminal not only reports the amplitude coefficient of each subband, but also reports the CQI of each subband, and the terminal indicates the CQI of each subband by carrying the third bit information in the channel state information.

Optionally, the third bit information indicates an absolute value of a CQI corresponding to each subband.

Optionally, the third bit information indicates a differential value between the CQI of the second subband and the CQI of the first subband, and the CQI of the first subband is an absolute value of the CQI.

For example, the product or sum of the differential value of the CQI of the second subband and the absolute value of the CQI of the first subband is determined as the value of the CQI of the second subband.

For example, the CQI of the second subband includes the first CQI, the second CQI and the third CQI, and the differential value indicated by the third bit information corresponding to the first CQI is 0.4, then the first CQI is the product or sum of 0.4 and the absolute value of the first subband CQI, the differential value indicated by the third bit information corresponding to the second CQI is 0.5, then the first CQI is the product or sum of 0.5 and the absolute value of the first subband CQI, and the differential value indicated by the third bit information corresponding to the third CQI is 0.7, then the first CQI is the product or sum of 0.7 and the absolute value of the first subband CQI.

After receiving the channel state information sent by the terminal, the network device determines the CQI corresponding to each subband based on the third bit information included in the channel state information.

In the embodiment, after the network device receives the third bit of information, it can determine the absolute value of the CQI of the first subband, and can also determine the differential value between the CQI of the second subband and the CQI of the first subband. Therefore, according to the differential value of each CQI of the second subband and the absolute value of the CQI of the first subband, the CQI corresponding to each subband is determined.

Also, the manner of determining the CQI of the second subband is similar to the above, which will not be described in detail herein.

It should be noted that the steps performed in the embodiments of the present application are similar to the steps performed in the above embodiments and will not be repeated here.

FIG. 4 illustrates a flow chart of an information transmission method provided by an exemplary embodiment of the present application. Referring to FIG. 4, the method includes:

Step 401: A network device receives channel state information sent by a terminal, where the channel state information includes channel state information corresponding to at least two layers, or the channel state information includes channel state information corresponding to at least two subbands, and the channel state information indicates an amplitude coefficient of each layer or each subband.

In an embodiment of the present application, the terminal may send channel state information corresponding to at least two layers or at least two subbands to a network device, and use the channel state information to indicate the amplitude coefficient of each layer or each subband to inform the network device of the amplitude coefficient of each layer or each subband.

In the embodiment, the layer is the number of layers transmitted by the terminal. Further, the number of layers is defined as the RANK (rank) of the MIMO channel matrix. That is, the number of layers of the terminal is equal to the RANK number. When the RANK is 1, the number of layers is 1, and when the RANK is N, the number of layers is N. The amplitude coefficient indicates the amplitude of the signal transmitted by the layer or subband.

It should be noted that the channel state information in the embodiments of the present application includes channel state information corresponding to at least two layers, or includes channel state information corresponding to at least two subbands. When the channel state information includes channel state information corresponding to at least two layers, the channel state information indicates the amplitude coefficient of each layer, and when the channel state information includes channel state information corresponding to at least two subbands, the channel state information indicates the amplitude coefficient of each subband.

By carrying vector information in the channel state information, then the amplitude coefficient is indicated through the vector information, the following two situations are included.

The first type: the channel state information includes vector information corresponding to each layer, and the vector information indicates an amplitude coefficient of the layer.

In the embodiment of the present application, the channel state information includes vector information corresponding to each layer, that is, the vector information corresponding to each layer indicates the amplitude coefficient of the layer. In the embodiment, the layer is layer, RANK=1 corresponds to one layer, and the RANK value is N, which means that N layers are supported.

The second type: the channel state information includes vector information corresponding to each subband, and the vector information indicates the amplitude coefficient of the subband.

In the embodiment of the present application, the channel state information includes vector information corresponding to each sub-band, that is, the vector information corresponding to each sub-band indicates the amplitude coefficient of the sub-band.

Optionally, the vector information includes a characteristic vector or a singular vector. When the vector information includes a characteristic vector, the amplitude coefficient is indicated by the characteristic vector. When the vector information includes a singular vector, the amplitude coefficient is indicated by the singular vector.

In some embodiments, the vector information includes first bit information, and the first bit information has a corresponding relationship with an element in the vector information.

In an embodiment of the present application, the first bit information included in the vector information indicates the value of the element included in the vector information. In the embodiment, the first bit information has a corresponding relationship with the element in the vector information, and the value of the element in the vector information can be determined by the first bit information and the corresponding relationship.

For example, if the vector information includes elements a, b, c, and d, the first bit information means that 000 indicates that the values corresponding to a, b, c, and d are 1, 2, 5, and 3 respectively; and 001 indicates that the values corresponding to a, b, c, and d are 3, 4, 1, and 3 respectively. Alternatively, the first bit information has other corresponding relationships with the elements.

In another embodiment of the present application, multiple vectors can be combined into a matrix, and the vector information includes first bit information for indicating the matrix combined from the multiple vectors, and the first bit information has a corresponding relationship with the elements in the matrix.

In some embodiment, the elements in the vector information include the amplitude coefficient corresponding to at least one port, or the elements in the vector information include the corresponding amplitude coefficient corresponding to at least one beam.

In the embodiment, for each layer, each layer includes at least one port, and the vector information corresponding to each layer includes the amplitude coefficient of at least one port included in the layer, that is, the value of each element included in the vector information is the amplitude coefficient of a port.

In the embodiment, for each subband, each subband includes at least one beam, and the vector information corresponding to each subband includes the amplitude coefficient of at least one beam included in the subband, that is, the value of each element included in the vector information is the amplitude coefficient of a beam.

In the embodiment, the port refers to CSI-RS (Channel State Information Reference Signal) port, or, antenna port. The beam refers to a beam.

In some embodiments, the amplitude coefficient of each layer in the at least two layers is the length of the vector information corresponding to the layer.

In an embodiment of the present application, when determining the amplitude coefficient of each layer in at least two layers, the length of the vector information corresponding to each layer is determined as the amplitude coefficient of the layer, and the amplitude coefficient of each layer is associated with the amplitude coefficient corresponding to at least one port included in the vector information.

Optionally, in response to the vector information being a real number vector, the length of the vector information is the sum of the absolute values of each element in the real number vector.

For example, for a vector [a, b, c, d], the length of the vector is the sum of the absolute values of a, b, c, d. When feedback of channel state information is provided, the vector is normalized so that its length is 1, that is, each element of the vector is divided by the length of the vector.

Optionally, in response to the vector information being a complex vector, the length of the vector information is the sum of the modulus of each element in the complex vector.

For example, a vector [a+i*a′, b+i*b′, c+i*c′, d+i*d′], the length of which is the sum value of the modulus of each element, that is, the sum value is the sum of square roots of the quadratic sum of a and a′, b and b′, c and c′, respectively. When the channel state information is fed back, the vector is normalized so that its length is 1, that is, the real part and the imaginary part of each element of the vector are divided by the length of the vector.

In some other embodiments, the amplitude coefficient of each subband in at least two subbands is the length of the vector information corresponding to the subband, and the amplitude coefficient of each subband is associated with the amplitude coefficient corresponding to at least one beam included in the vector information.

In the embodiment of the present application, when determining the amplitude coefficient of each sub-band in at least two sub-bands, the length of the vector information corresponding to each sub-band is determined as the amplitude coefficient of the sub-band.

In addition, when determining the amplitude coefficient of each sub-band, it is similar to determining the amplitude coefficient of each layer in the above embodiment, and will not be repeated here.

It should be noted that in the embodiment of the present application, the difference in amplitude coefficients between different layers or subbands is indicated by the length of the vector information, and when the channel state information is fed back, the vector is normalized. During the normalization process, for the network device, since the length of the vector information indicates the amplitude coefficient, the length of the vector information with the largest amplitude coefficient is normalized to 1, and the normalized length 1 is used as the amplitude coefficient of the vector information with the largest amplitude coefficient. For other vector information whose amplitude coefficient is less than the amplitude coefficient of the vector information with the largest amplitude coefficient, the normalized length of the other vector information is determined according to the ratio of the amplitude coefficient of the other vector information to the amplitude coefficient of the vector information with the largest amplitude coefficient, and the normalized length of the other vector information is determined as the amplitude coefficient of the other vector information. Therefore, the network device can determine the difference in amplitude coefficients between different vectors based on the first bit of information in the vector information.

In some embodiments, the length of the vector information with the largest amplitude coefficient is normalized to 1, and the normalized length 1 is used as the amplitude coefficient of the vector information. That is, the amplitude coefficient of the vector information with the largest amplitude coefficient is the length 1 of the vector information. For other vector information, the ratio of the amplitude coefficient of the other vector information to the amplitude coefficient of the vector information with the largest amplitude coefficient is used as the normalized length of the other vector information, and the normalized length of the other vector information is used as the amplitude coefficient of the other vector information.

For example, two pieces of vector information are used as an example for explanation. The two pieces of vector information are vector 1 and vector 2, respectively. The amplitude coefficient of vector 1 is greater than the amplitude coefficient of vector 2. For vector 1, the length of vector 1 is normalized to 1, and the length of vector 2 is normalized to 1/L, where L is the ratio of the amplitude coefficient of vector 1 to the amplitude coefficient of vector 2. That is, the embodiment of the present application indicates the amplitude coefficients of different vectors by the ratio of the lengths of the two pieces of vector information, and the difference in amplitude coefficients between different vector information can be determined by indicating the first bit of the vector information.

In some embodiments, the channel state information includes second bit information, and the amplitude coefficient of each layer in the at least two layers is indicated by the second bit information.

In an embodiment of the present application, the terminal indicates the amplitude coefficient of each layer through the second bit information in the channel state information.

Optionally, the second bit information indicates a differential value between an amplitude coefficient of the second layer and an amplitude coefficient of the first layer, and the amplitude coefficient of the first layer is 1.

In the embodiment, the amplitude coefficient of the first layer is agreed upon by the communication protocol or pre-set by the terminal, and is not limited in the embodiment of the present application.

For example, the first layer includes layer 1, the second layer includes layer 2 and layer 3, the differential value indicated by the second bit information corresponding to layer 2 is 0.2, then the amplitude coefficient of layer 2 is 0.2 times that of layer 1, and the differential value indicated by the second bit information corresponding to layer 3 is 0.1, then the amplitude coefficient of layer 3 is 0.1 times that of layer 1.

Optionally, the second bit information directly indicates the amplitude coefficient of each layer. For example, the second bit information indicates the amplitude coefficients of three layers, namely, layer 1, layer 2 and layer 3, and the second bit information indicates that the amplitude coefficient of layer 1 is 1, the amplitude coefficient of layer 2 is 0.8, and the amplitude coefficient of layer 3 is 0.5.

In some other embodiments, the channel state information includes second bit information, and the amplitude coefficient of each subband in the at least two subbands is indicated by the second bit information.

In an embodiment of the present application, the terminal indicates the amplitude coefficient of each subband through the second bit information in the channel state information.

Optionally, the second bit information indicates a differential value between an amplitude coefficient of the second sub-band and an amplitude coefficient of the first sub-band, and the amplitude coefficient of the first sub-band is 1.

In the embodiment, the amplitude coefficient of the first sub-band is agreed upon by the communication protocol or pre-set by the terminal, and is not limited in the embodiment of the present application.

For example, the first subband includes subband 1, the second subband includes subband 2 and subband 3, the differential value indicated by the second bit information corresponding to subband 2 is 0.2, then the amplitude coefficient of subband 2 is 0.2 times that of subband 1, and the differential value indicated by the second bit information corresponding to subband 3 is 0.1, then the amplitude coefficient of subband 3 is 0.1 times that of subband 1.

It should be noted that the channel state information in the embodiment of the present application may include not only the second bit information, but also the first bit information in the above embodiment.

In the embodiment, the first bit information is similar to that in the above embodiment and will not be repeated here.

In the implementation provided by the embodiment of the present application, the network device can not only determine the vector information indicated by the first bit information, and then determine the amplitude coefficient of each port or beam based on the amplitude coefficient indicated by the element of the vector information, but also determine the amplitude coefficients of different layers or different subbands indicated by the second bit information, so that the network device can increase the information for reference when communicating with the terminal based on the amplitude coefficient of the layer or subband, and the amplitude coefficient of the port included in the layer or the beam included in the subband, thereby further improving the communication reliability.

In some embodiments, the terminal carries third bit information in the channel state information, and indicates a CQI corresponding to each layer in at least two layers through the third bit information.

In the embodiment of the present application, the terminal not only reports the amplitude coefficient of each layer, but also reports the CQI of each layer, and the terminal indicates the CQI of each layer by carrying the third bit information in the channel state information.

Optionally, the third bit information indicates an absolute value of a CQI corresponding to each layer.

Optionally, the third bit information indicates a differential value between the CQI of the second layer and the CQI of the first layer, and the CQI of the first layer is an absolute value of the CQI.

For example, the product or sum of the differential value of the CQI of the second layer and the absolute value of the CQI of the first layer is determined as the value of the CQI of the second layer.

For example, the CQI of the second layer includes a first CQI, a second CQI, and a third CQI, and the differential value indicated by the third bit information corresponding to the first CQI is 0.4, then the first CQI is the product or sum of 0.4 and the absolute value of the first-layer CQI, the differential value indicated by the third bit information corresponding to the second CQI is 0.5, then the first CQI is the product or sum of 0.5 and the absolute value of the first-layer CQI, and the differential value indicated by the third bit information corresponding to the third CQI is 0.7, then the first CQI is the product or sum of 0.7 and the absolute value of the first-layer CQI.

After receiving the channel state information sent by the terminal, the network device can determine the CQI corresponding to each layer based on the third bit information included in the channel state information.

In the embodiment, the network device can determine the absolute value of the CQI of the first layer based on the third bit information, and can also determine the differential value between the CQI of the second layer and the CQI of the first layer. Therefore, the CQI corresponding to each layer is determined according to the differential value of each CQI of the second layer and the absolute value of the CQI of the first layer.

Furthermore, the method for determining the CQI of the second layer is similar to the above, which will not be described in detail here.

In the solution provided in the embodiment of the present application, the terminal indicates the CQI corresponding to each layer by carrying the third bit information in the channel state information, thereby increasing the amount of information transmission, and the CQI can indicate the channel quality, so that the network device can transmit data based on the CQI, thereby ensuring the reliability of communication.

On the basis of the embodiment shown in FIG. 2, the terminal carries third bit information in the channel state information, and the third bit information indicates the CQI corresponding to each subband in at least two subbands.

In the embodiment of the present application, the terminal not only reports the amplitude coefficient of each subband, but also reports the CQI of each subband, and the terminal indicates the CQI of each subband by carrying the third bit information in the channel state information.

Optionally, the third bit information indicates an absolute value of a CQI corresponding to each subband.

Optionally, the third bit information indicates a differential value between the CQI of the second subband and the CQI of the first subband, and the CQI of the first subband is an absolute value of the CQI.

For example, the product or sum of the differential value of the CQI of the second subband and the absolute value of the CQI of the first subband is determined as the value of the CQI of the second subband.

For example, the CQI of the second subband includes the first CQI, the second CQI and the third CQI, and the differential value indicated by the third bit information corresponding to the first CQI is 0.4, then the first CQI is the product or sum of 0.4 and the absolute value of the first subband CQI, the differential value indicated by the third bit information corresponding to the second CQI is 0.5, then the first CQI is the product or sum of 0.5 and the absolute value of the first subband CQI, and the differential value indicated by the third bit information corresponding to the third CQI is 0.7, then the first CQI is the product or sum of 0.7 and the absolute value of the first subband CQI.

After receiving the channel state information sent by the terminal, the network device determines the CQI corresponding to each subband based on the third bit information included in the channel state information.

In the embodiment, after the network device receives the third bit of information, it can determine the absolute value of the CQI of the first subband, and can also determine the differential value between the CQI of the second subband and the CQI of the first subband. Therefore, according to the differential value of each CQI of the second subband and the absolute value of the CQI of the first subband, the CQI corresponding to each subband is determined.

Also, the manner of determining the CQI of the second subband is similar to the above, which will not be described in detail herein. It should be noted that the steps performed in the embodiments of the present application are similar to the steps performed in the above embodiments and will not be repeated here.

FIG. 5 illustrates a block diagram of an information transmission device provided by an exemplary embodiment of the present application. Referring to FIG. 5, the device includes:

a sending module 501, configured to send channel state information to a network device, where the channel state information includes channel state information corresponding to at least two layers, or the channel state information includes channel state information corresponding to at least two subbands, and the channel state information indicates an amplitude coefficient of each layer or each subband.

In some embodiments, the channel state information includes vector information corresponding to each layer, and the vector information indicates the amplitude coefficient of the layer;
or,
wherein the channel state information includes vector information corresponding to each subband, and the vector information indicates the amplitude coefficient of the subband.

In some embodiments, the vector information includes first bit information, and the first bit information has a corresponding relationship with an element in the vector information.

In some embodiments, the element in the vector information includes an amplitude coefficient corresponding to at least one port, or the element in the vector information includes an amplitude coefficient corresponding to at least one beam.

In some embodiments, the amplitude coefficient of each layer in the at least two layers is a length of the vector information corresponding to the layer, and the amplitude coefficient of each layer is associated with the amplitude coefficient corresponding to the at least one port included in the vector information;
or,
wherein the amplitude coefficient of each subband of the at least two subbands is a length of the vector information corresponding to the subband, and the amplitude coefficient of each subband is associated with the amplitude coefficient corresponding to the at least one beam included in the vector information.

In some embodiments, the channel state information includes second bit information, and the amplitude coefficient of each layer in the at least two layers is indicated by the second bit information;
or,
wherein the channel state information includes second bit information, and the amplitude coefficient of each subband in the at least two subbands is indicated by the second bit information.

In some embodiments, the second bit information indicates a differential value between an amplitude coefficient of the second layer and an amplitude coefficient of the first layer, and the amplitude coefficient of the first layer is 1;
or,
wherein the second bit information indicates a differential value between an amplitude coefficient of the second sub-band and an amplitude coefficient of the first sub-band, and the amplitude coefficient of the first sub-band is 1.

In some embodiments, the channel state information further includes third bit information; and
the third bit information indicates a CQI corresponding to each layer in the at least two layers;
or,
the third bit information indicates a CQI corresponding to each subband of the at least two subbands.

It should be noted that the device provided in the above embodiment, when implementing its functions, only uses the division of the above functional modules as an example. In actual applications, the above functions can be assigned to different functional modules as needed, that is, the internal structure of the device is divided into different functional modules to complete all or part of the functions described above. In addition, the device and method embodiments provided in the above embodiment belong to the same concept, and the specific implementation process is detailed in the method embodiment, which will not be repeated here.

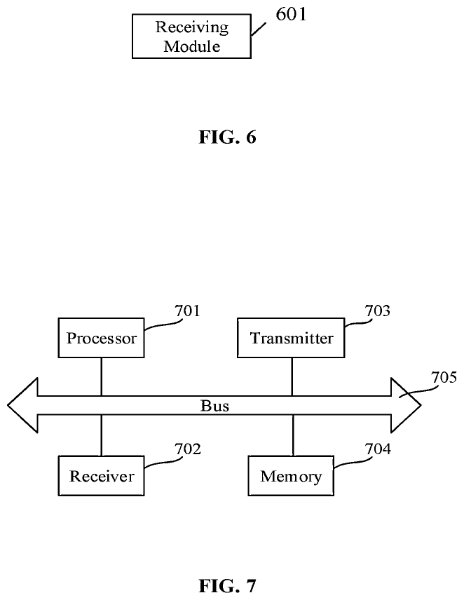

FIG. 6 illustrates a block diagram of an information transmission device provided by an exemplary embodiment of the present application. Referring to FIG. 6, the device includes:
a receiving module 601, configured to receive channel state information sent by a terminal, wherein the channel state information includes channel state information corresponding to at least two layers, or the channel state information includes channel state information corresponding to at least two subbands, and the channel state information indicates an amplitude coefficient of each layer or each subband.

In some embodiments, the channel state information includes vector information corresponding to each layer, and the vector information indicates the amplitude coefficient of the layer;
or,
wherein the channel state information includes vector information corresponding to each subband, and the vector information indicates the amplitude coefficient of the subband.

In some embodiments, the vector information includes first bit information, and the first bit information has a corresponding relationship with an element in the vector information.

In some embodiments, the element in the vector information includes an amplitude coefficient corresponding to at least one port, or the element in the vector information includes an amplitude coefficient corresponding to at least one beam.

In some embodiments, the amplitude coefficient of each layer in the at least two layers is a length of the vector information corresponding to the layer, and the amplitude coefficient of each layer is associated with the amplitude coefficient corresponding to the at least one port included in the vector information;
or,
wherein the amplitude coefficient of each subband of the at least two subbands is a length of the vector information corresponding to the subband, and the amplitude coefficient of each subband is associated with the amplitude coefficient corresponding to the at least one beam included in the vector information.

In some embodiments, the channel state information includes second bit information, and the amplitude coefficient of each layer in the at least two layers is indicated by the second bit information;
or,
wherein the channel state information includes second bit information, and the amplitude coefficient of each subband in the at least two subbands is indicated by the second bit information.

In some embodiments, the second bit information indicates a differential value between an amplitude coefficient of the second layer and an amplitude coefficient of the first layer, and the amplitude coefficient of the first layer is 1;
or,
wherein the second bit information indicates a differential value between an amplitude coefficient of the second sub-band and an amplitude coefficient of the first sub-band, and the amplitude coefficient of the first sub-band is 1.

In some embodiments, the channel state information further includes third bit information; and
the third bit information indicates a CQI corresponding to each layer in the at least two layers;
or,
the third bit information indicates a CQI corresponding to each subband of the at least two subbands.

It should be noted that the device provided in the above embodiment, when implementing its functions, only uses the division of the above functional modules as an example. In actual applications, the above functions can be assigned to different functional modules as needed, that is, the internal structure of the device is divided into different functional modules to complete all or part of the functions described above. In addition, the device and method embodiments provided in the above embodiment belong to the same concept, and the specific implementation process is detailed in the method embodiment, which will not be repeated here.

FIG. 7 illustrates a schematic diagram of the structure of a communication device provided by an exemplary embodiment of the present application. The communication device includes: a processor 701, a receiver 702, a transmitter 703, a memory 704 and a bus 705.

The processor 701 includes one or more processing cores. The processor 701 executes various functional applications and information processing by running software programs and modules.

The receiver 702 and the transmitter 703 may be implemented as a communication component, which may be a communication chip.

The memory 704 is connected to the processor 701 via a bus 705.

The memory 704 may be configured to store at least one program code, and the processor 701 may be used to execute the at least one program code to implement each step in the above method embodiment.

In addition, the communication device may be a terminal or a network device. The memory 704 may be implemented by any type of volatile or non-volatile storage device or a combination thereof, and the volatile or non-volatile storage device includes but is not limited to: a magnetic disk or optical disk, an electrically erasable programmable read-only memory (EEPROM), an erasable programmable read-only memory (EPROM), a static random access memory (SRAM), a read-only memory (ROM), a magnetic memory, a flash memory, and a programmable read-only memory (PROM).

In an exemplary embodiment, a computer-readable storage medium is also provided, in which executable program code is stored. The executable program code is loaded and executed by a processor to implement the information transmission method performed by a communication device provided by each of the above method embodiments.

In an exemplary embodiment, a chip is provided, which includes a programmable logic circuit and/or program instructions. When the chip is operated on a terminal or a network device, it is used to implement the information transmission method provided in each method embodiment.

In an exemplary embodiment, a computer program product is provided. When the computer program product is executed by a processor of a terminal or a network device, it is used to implement the information transmission method provided by each of the above method embodiments.

A person skilled in the art will understand that all or part of the steps to implement the above embodiments may be accomplished by hardware or by instructing related hardware through a program, and the program may be stored in a computer-readable storage medium, and the above-mentioned storage medium may be a read-only memory, a disk or an optical disk, etc.

The above description is only an optional embodiment of the present application and is not intended to limit the present application. Any modifications, equivalent substitutions, improvements, etc. made within the spirit and principles of the present application shall be included in the protection scope of the present application.

What is claimed is:

1. An information transmission method, executed by a terminal, and comprising:
sending channel state information to a network device, wherein the channel state information comprises channel state information corresponding to at least two layers, or the channel state information comprises channel state information corresponding to at least two subbands, and the channel state information indicates an amplitude coefficient of each layer or each subband.

2. The method according to claim 1, wherein the channel state information comprises vector information corresponding to each layer, and the vector information indicates the amplitude coefficient of the layer;
or,
wherein the channel state information comprises vector information corresponding to each subband, and the vector information indicates the amplitude coefficient of the subband.

3. The method according to claim 2, wherein the vector information comprises first bit information, and the first bit information has a corresponding relationship with an element in the vector information.

4. The method according to claim 3, wherein the element in the vector information comprises an amplitude coefficient corresponding to at least one port, or the element in the vector information comprises an amplitude coefficient corresponding to at least one beam.

5. The method according to any one of claims 2 to 4, wherein the amplitude coefficient of each layer in the at least two layers is a length of the vector information corresponding to the layer, and the amplitude coefficient of each layer is associated with the amplitude coefficient corresponding to the at least one port comprised in the vector information;
or,
wherein the amplitude coefficient of each subband of the at least two subbands is a length of the vector information corresponding to the subband, and the amplitude coefficient of each subband is associated with the amplitude coefficient corresponding to the at least one beam comprised in the vector information.

6. The method according to any one of claims 1 to 4, wherein the channel state information comprises second bit information, and the amplitude coefficient of each layer in the at least two layers is indicated by the second bit information;
or,
wherein the channel state information comprises second bit information, and the amplitude coefficient of each subband in the at least two subbands is indicated by the second bit information.

7. The method according to claim 6, wherein the second bit information indicates a differential value between an amplitude coefficient of the second layer and an amplitude coefficient of the first layer, and the amplitude coefficient of the first layer is 1;
or,
wherein the second bit information indicates a differential value between an amplitude coefficient of the second sub-band and an amplitude coefficient of the first sub-band, and the amplitude coefficient of the first sub-band is 1.

8. The method according to any one of claims 3 to 7, wherein the channel state information further comprises third bit information; and
the third bit information indicates a channel quality indicator CQI corresponding to each layer in the at least two layers;
or,
the third bit information indicates a CQI corresponding to each subband of the at least two subbands.

9. An information transmission method, executed by a network device, and comprising:
receiving channel state information sent by a terminal, wherein the channel state information comprises channel state information corresponding to at least two layers, or the channel state information comprises channel state information corresponding to at least two subbands, and the channel state information indicates an amplitude coefficient of each layer or each subband.

10. The method according to claim 9, wherein the channel state information comprises vector information corresponding to each layer, and the vector information indicates the amplitude coefficient of the layer;
or,
wherein the channel state information comprises vector information corresponding to each subband, and the vector information indicates the amplitude coefficient of the subband.

11. The method according to claim 10, wherein the vector information comprises first bit information, and the first bit information has a corresponding relationship with an element in the vector information.

12. The method according to claim 11, wherein the element in the vector information comprises an amplitude coefficient corresponding to at least one port, or the element in the vector information comprises an amplitude coefficient corresponding to at least one beam.

13. The method according to any one of claims 10 to 12, wherein the amplitude coefficient of each layer in the at least two layers is a length of the vector information corresponding to the layer, and the amplitude coefficient of each layer is associated with the amplitude coefficient corresponding to the at least one port comprised in the vector information;
or,
wherein the amplitude coefficient of each subband of the at least two subbands is a length of the vector information corresponding to the subband, and the amplitude coefficient of each subband is associated with the amplitude coefficient corresponding to the at least one beam comprised in the vector information.

14. The method according to any one of claims 9 to 12, wherein the channel state information comprises second bit information, and the amplitude coefficient of each layer in the at least two layers is indicated by the second bit information;
or,
wherein the channel state information comprises second bit information, and the amplitude coefficient of each subband in the at least two subbands is indicated by the second bit information.

15. The method according to claim 14, wherein the second bit information indicates a differential value between an amplitude coefficient of the second layer and an amplitude coefficient of the first layer, and the amplitude coefficient of the first layer is 1;
or,
wherein the second bit information indicates a differential value between an amplitude coefficient of the second sub-band and an amplitude coefficient of the first sub-band, and the amplitude coefficient of the first sub-band is 1.

16. The method according to any one of claims 11 to 15, wherein the channel state information further comprises third bit information; and
the third bit information indicates a CQI corresponding to each layer in the at least two layers;
or,
the third bit information indicates a CQI corresponding to each subband of the at least two subbands.

17. An information transmission apparatus, comprising:
a sending module, configured to send channel state information to a network device, wherein the channel state information comprises channel state information corresponding to at least two layers, or the channel state information comprises channel state information corresponding to at least two subbands, and the channel state information indicates an amplitude coefficient of each layer or each subband.

18. The apparatus according to claim 17, wherein the channel state information comprises vector information corresponding to each layer, and the vector information indicates the amplitude coefficient of the layer;
or,
wherein the channel state information comprises vector information corresponding to each subband, and the vector information indicates the amplitude coefficient of the subband.

19. The apparatus according to claim 18, wherein the vector information comprises first bit information, and the first bit information has a corresponding relationship with an element in the vector information.

20. The apparatus according to claim 19, wherein the element in the vector information comprises an amplitude coefficient corresponding to at least one port, or the element in the vector information comprises an amplitude coefficient corresponding to at least one beam.

21. The apparatus according to any one of claims 18 to 20, wherein the amplitude coefficient of each layer in the at least two layers is a length of the vector information corresponding to the layer, and the amplitude coefficient of each layer is associated with the amplitude coefficient corresponding to the at least one port comprised in the vector information;
or,
wherein the amplitude coefficient of each subband of the at least two subbands is a length of the vector information corresponding to the subband, and the amplitude coefficient of each subband is associated with the amplitude coefficient corresponding to the at least one beam comprised in the vector information.

22. The apparatus according to any one of claims 17 to 20, wherein the channel state information comprises second bit information, and the amplitude coefficient of each layer in the at least two layers is indicated by the second bit information;
or,
wherein the channel state information comprises second bit information, and the amplitude coefficient of each subband in the at least two subbands is indicated by the second bit information.

23. The apparatus according to claim 22, wherein the second bit information indicates a differential value between an amplitude coefficient of the second layer and an amplitude coefficient of the first layer, and the amplitude coefficient of the first layer is 1;
or,
wherein the second bit information indicates a differential value between an amplitude coefficient of the second sub-band and an amplitude coefficient of the first sub-band, and the amplitude coefficient of the first sub-band is 1.

24. The apparatus according to any one of claims 19 to 23, wherein the channel state information further comprises third bit information; and
the third bit information indicates a CQI corresponding to each layer in the at least two layers;
or,
the third bit information indicates a CQI corresponding to each subband of the at least two subbands.

25. An information transmission apparatus, comprising:
a receiving module, configured to receive channel state information sent by a terminal, wherein the channel state information comprises channel state information corresponding to at least two layers, or the channel state information comprises channel state information corresponding to at least two subbands, and the channel state information indicates an amplitude coefficient of each layer or each subband.

26. The apparatus according to claim 25, wherein the channel state information comprises vector information corresponding to each layer, and the vector information indicates the amplitude coefficient of the layer;
or,
wherein the channel state information comprises vector information corresponding to each subband, and the vector information indicates the amplitude coefficient of the subband.

27. The apparatus according to claim 26, wherein the vector information comprises first bit information, and the first bit information has a corresponding relationship with an element in the vector information.

28. The apparatus according to claim 27, wherein the element in the vector information comprises an amplitude coefficient corresponding to at least one port, or the element in the vector information comprises an amplitude coefficient corresponding to at least one beam.

29. The apparatus according to any one of claims 26 to 28, wherein the amplitude coefficient of each layer in the at least two layers is a length of the vector information corresponding to the layer, and the amplitude coefficient of each layer is associated with the amplitude coefficient corresponding to the at least one port comprised in the vector information;
or,
wherein the amplitude coefficient of each subband of the at least two subbands is a length of the vector information corresponding to the subband, and the amplitude coefficient of each subband is associated with the amplitude coefficient corresponding to the at least one beam comprised in the vector information.

30. The apparatus according to any one of claims 25 to 28, wherein the channel state information comprises second bit information, and the amplitude coefficient of each layer in the at least two layers is indicated by the second bit information;
or,
wherein the channel state information comprises second bit information, and the amplitude coefficient of each subband in the at least two subbands is indicated by the second bit information.

31. The apparatus according to claim 30, wherein the second bit information indicates a differential value between an amplitude coefficient of the second layer and an amplitude coefficient of the first layer, and the amplitude coefficient of the first layer is 1;
or,
wherein the second bit information indicates a differential value between an amplitude coefficient of the second sub-band and an amplitude coefficient of the first sub-band, and the amplitude coefficient of the first sub-band is 1.

32. The apparatus according to any one of claims 27 to 31, wherein the channel state information further comprises third bit information; and
the third bit information indicates a CQI corresponding to each layer in the at least two layers;
or,
the third bit information indicates a CQI corresponding to each subband of the at least two subbands.

33. A terminal, comprising:
a processor; and
a transceiver connected to the processor;
wherein the processor is configured to load and execute executable instructions to implement the information transmission method according to any one of claims 1 to 8.

34. A network device, comprising:
a processor; and
a transceiver connected to the processor;
wherein the processor is configured to load and execute executable instructions to implement the information transmission method according to any one of claims 9 to 16.

35. A computer-readable storage medium, in which an executable program code is stored, and the executable program code is loaded and executed by a processor to implement the information transmission method according to any one of claims 1 to 16.

36. A computer program product, which when being executed by a processor of a terminal or a network device, the information transmission method according to any one of claims 1 to 16 is implemented.
